(19) United States
(12) Patent Application Publication
(10) Pub. No.: US 2018/0223652 A1
(43) Pub. Date: Aug. 9, 2018

(54) Dual Frequency Elements For Wellbore Communications

(71) Applicant: Halliburton Energy Services, Inc., Houston, TX (US)

(72) Inventor: Mark W. Roberson, Houston, TX (US)

(21) Appl. No.: 15/749,585

(22) PCT Filed: Sep. 16, 2015
(86) PCT No.: PCT/US2015/050345

§ 371 Date: Feb. 1, 2018

(51) Int. Cl. E21B 47/12; H04L 5/06; E21B 47/00; E21B 33/14

(52) U.S. Cl. CPC E21B 47/122; E21B 33/14; E21B 47/0005; H04L 5/06

(57) ABSTRACT

Methods and systems are presented in this disclosure for performing multi-frequency communications during wellbore operations. Communication of data related to a state of a wellbore (e.g., characteristics and/or locations of one or more fluids flowing along a casing in the wellbore during a cementing operation) can be performed simultaneously or sequentially involving a plurality of nodes located along the casing in the wellbore, wherein each of the nodes is configured to use a different frequency for communication. In this way, a higher information throughput and more reliable communication can be achieved during wellbore operations.

### TECHNICAL FIELD

The present disclosure generally relates to communications during downhole operations and, more particularly, to dual frequency elements for wellbore communications.

### BACKGROUND

Natural resources such as gas, oil, and water residing in a subterranean formation or zone are usually recovered by drilling a wellbore into the subterranean formation while circulating a drilling fluid in the wellbore. After terminating the circulation of the drilling fluid, a string of pipe (e.g., casing) is run in the wellbore. The drilling fluid is then usually circulated downward through the interior of the pipe and upward through an annulus, which is located between the exterior of the pipe and the walls of the wellbore. Next, cementing is typically performed is whereby a cement slurry is placed in the annulus and permitted to set into a hard mass (i.e., sheath) to seal the annulus.

An ongoing need exists for methods and apparatus for monitoring wellbore cementing operation from placement through the service lifetime of cementing fluids. Information about conditions of cementing fluids along the casing may be communicated to a well operator. Hence, it is desirable to develop efficient elements (apparatus) for communications.

### BRIEF DESCRIPTION OF THE DRAWINGS

Various embodiments of the present disclosure will be understood more fully from the detailed description given below and from the accompanying drawings of various embodiments of the disclosure. In the drawings, like reference numbers may indicate identical or functionally similar elements.

FIG. 1 is a cross-sectional view of an example of a well system that includes a system for determining characteristics of a fluid in a wellbore and/or in an annulus between a casing and a reservoir formation, according to certain embodiments of the present disclosure.

FIG. 2 is a cross-sectional view of a casing with different implementations of nodes along the casing, according to certain embodiments of the present disclosure.

FIG. 3 is a flow chart of a method for multi-frequency communications, according to certain embodiments of the present disclosure.

FIG. 4 is a block diagram of an illustrative computer system in which embodiments of the present disclosure may be implemented.

### DETAILED DESCRIPTION

Embodiments of the present disclosure relate to multi-frequency elements for communications during wellbore operations. While the present disclosure is described herein with reference to illustrative embodiments for particular applications, it should be understood that embodiments are not limited thereto. Other embodiments are possible, and modifications can be made to the embodiments within the spirit and scope of the teachings herein and additional fields in which the embodiments would be of significant utility.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described. It would also be apparent to one skilled in the relevant art that the embodiments, as described herein, can be implemented in many different embodiments of software, hardware, firmware, and/or the entities illustrated in the figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

The disclosure may repeat reference numerals and/or letters in the various examples or Figures. This repetition is for the purpose of simplicity and clarity and does not in itself dictate a relationship between the various embodiments and/or configurations discussed. Further, spatially relative terms, such as beneath, below, lower, above, upper, uphole, downhole, upstream, downstream, and the like, may be used herein for ease of description to describe one element or feature's relationship to another element(s) or feature(s) as illustrated, the upward direction being toward the top of the corresponding figure and the downward direction being toward the bottom of the corresponding figure, the uphole direction being toward the surface of the wellbore, the downhole direction being toward the toe of the wellbore. Unless otherwise stated, the spatially relative terms are intended to encompass different orientations of the apparatus in use or operation in addition to the orientation depicted in the Figures. For example, if an apparatus in the Figures is turned over, elements described as being “below” or “beneath” other elements or features would then be oriented “above” the other elements or features. Thus, the exemplary term “below” can encompass both an orientation of above and below. The apparatus may be otherwise oriented (rotated 90 degrees or at other orientations) and the spatially relative descriptors used herein may likewise be interpreted accordingly.

Moreover even though a Figure may depict a horizontal wellbore or a vertical wellbore, unless indicated otherwise, it should be understood by those skilled in the art that the apparatus according to the present disclosure is equally well suited for use in wellbores having other orientations including vertical wellbores, slanted wellbores, multilateral wellbores or the like. Likewise, unless otherwise noted, even though a Figure may depict an offshore operation, it should be understood by those skilled in the art that the apparatus according to the present disclosure is equally well suited for use in onshore operations and vice-versa. Further, unless otherwise noted, even though a Figure may depict a cased hole, it should be understood by those skilled in the art that the apparatus according to the present disclosure is equally well suited for use in open hole operations.

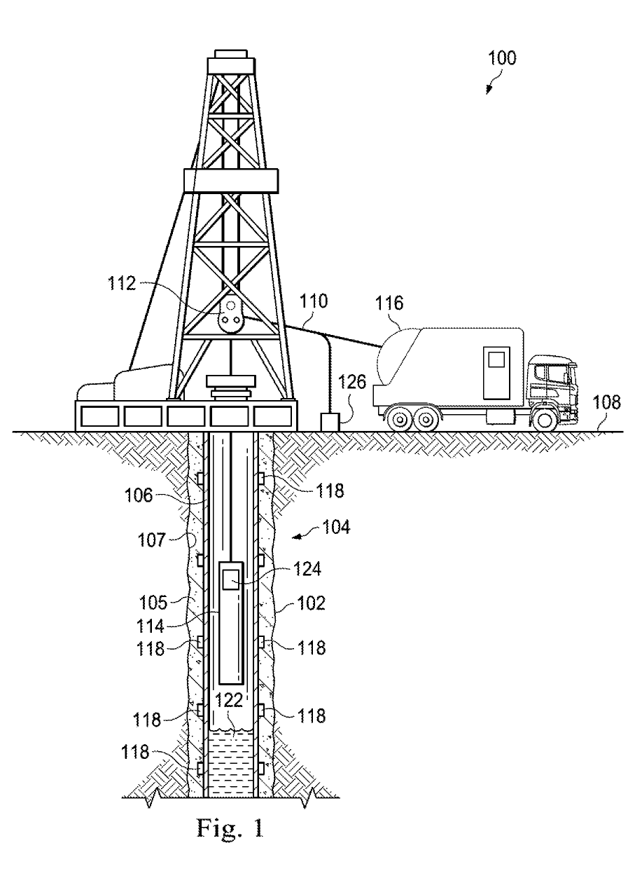

Illustrative embodiments and related methods of the present disclosure are described below in reference to FIGS. 1-4 as they might be employed for multi-frequency communications in wellbore operations, such as during and/or after a cementing operation. In the interest of clarity, not all features of an actual implementation or method are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. Further aspects and advantages of the various embodiments and related methods of the disclosure will become apparent from consideration of the following description and drawings.

FIG. 1 is a cross-sectional view of an example of a well system 100 that includes a system for determining characteristics of a fluid in a wellbore and/or in an annulus between a casing and a reservoir formation, according to certain embodiments of the present disclosure. The well system 100 includes a wellbore 102 extending through various earth strata. The wellbore 102 extends through a hydrocarbon bearing subterranean formation 104. A casing string 106 extends from the surface 108 to the subterranean formation 104. The casing string 106 can provide a conduit through which fluid 122, such as production fluids produced from the subterranean formation 104, can travel from the wellbore 102 to the surface 108. The casing string 106 can be coupled to the walls of the wellbore 102. For example, one or more fluids 105 (e.g., cementing fluids) can be pumped (e.g., using pumping equipment or a pump) in an annulus 107 between the casing string 106 and the walls of the wellbore 102 for coupling the casing string 106 to the wellbore 102. In one or more embodiments, fluid 105 pumped into the annulus 107 may be a cement slurry. Mixing equipment (not shown) may be utilized for mixing fluids and forming the cement slurry 105.

The well system 100 can also include at least one well tool 114 (e.g., a formation-testing tool). The well tool 114 can be coupled to a wireline 110, slickline, or coiled tube that can be deployed into the wellbore 102. The wireline 110, slickline, or coiled tube can be guided into the wellbore 102 using, for example, a guide 112 or winch. In some examples, the wireline 110, slickline, or coiled tube can be wound around a reel 116.

The well system 100 can include one or more nodes (sensors) 118 that may be located at discrete locations along the casing string 106 (e.g., external to the casing string 106) in the annulus region 107 of the wellbore 102. In one or more embodiments, the nodes 118 can include a protective housing (e.g., a fluid resistant housing). This can prevent the nodes 118 from being damaged by fluids 105, 122, the well tool 114, and/or debris downhole.

For certain embodiments, a node 118 can include an inclinometer. The inclinometer can determine the inclination of the well system 100 (e.g., by detecting the inclination of the casing string 106 to which the sensor 118 can be coupled). This can be particularly useful if the well system 100 is an angled well system (e.g., the wellbore 102 is drilled at an angle between 0 and 90 degrees). Additionally or alternatively, a node 118 can include a pH sensor. The pH sensor can determine the pH of one or more fluids 105, 122 in the wellbore 102. In some examples, the node 118 can additionally or alternatively include a hydrocarbon sensor. The hydrocarbon sensor can detect the presence of, or a characteristic of, a hydrocarbon in the wellbore 102.

For certain embodiments, the nodes 118 can be coupled external to the casing string 106 in the annulus 107. This can allow the nodes 118 to monitor the characteristics of the well system 100, even if the well tool 114 is removed or changed. For example, the node 118 can be positioned external to an outer housing of, or partially embedded within, the casing string 106. In one or more embodiments, the nodes 118 may be configured to directly communicate with Radio Frequency (RF) Micro-Electro-Mechanical System (MEMS) tags placed in one or more fluids flowing through the annulus 107 along the casing string 106 during the cementing operation. This can allow the nodes 118 to obtain information where a specific fluid is positioned along the casing string 106 in the annulus 107 at any time (e.g., during and/or after the cementing operation), which is of crucial importance for evaluating quality of the cementing operation in the wellbore.

In one or more embodiments, the nodes 118 can transmit data (e.g., via wires or wirelessly) with information about the characteristics of the wellbore 102, the fluids 105, and/or the fluid 122 to a receiver 124 of the well tool 114. In one or more other embodiments, the nodes 118 can transmit data (e.g., via wires or wirelessly) with information about the characteristics of the wellbore 102, the fluids 105, and/or the fluid 122 to a receiver 126 positioned on a surface 108. In one or more other embodiments, the nodes 118 can transmit data (e.g., wirelessly) with information about the characteristics of the wellbore 102, the fluids 105, and/or the fluid 122 to one or more other nodes 118. The information may be then relayed from the receiving nodes 118 to the receiver 124 and/or the receiver 126. In some embodiments, the nodes 118 can transmit data using very low frequency (VLF) magnetic or current pulses, ultrasonic pulses, acoustic pulses, electromagnetic coupling, inductive coupling, or any combination of these.

One or more receivers 124, 126 can be positioned in the well system 100 for receiving data from the nodes 118. In some embodiments, the receivers 124, 126 can be positioned on the well tool 114, on the casing string 106, or at the surface 108 of the well system 100. The receivers 124, 126 can directly or indirectly receive the data from the nodes 118. For example, a receiver 124 can wirelessly receive data from a node 118. The receiver 124 can then relay the data via wireline 110 to another receiver 126 at the surface 108. In some embodiments, the receiver 124 can include a distributed acoustic sensor (DAS). A DAS can include a fiber-optic device configured to detect acoustic transmissions (e.g., acoustic emissions) from the nodes 118. In some embodiments, the receiver 124 can use the DAS to receive (e.g., detect) acoustic transmissions from the node 118.

It may be desirable in wellbore applications to utilize substantially different frequencies in communications, for example, for long and short range communications. Embodiments of the present disclosure are directed to utilizing dual frequency nodes (or more generally, nodes having a plurality of frequency ranges) for communication of wellbore-related information. In one or more embodiments, nodes configured for multi-frequency communications may be the nodes 118 of the well system 100 from FIG. 1, wherein the multi-frequency nodes are located externally along the casing string 106 in the annulus 107 of the wellbore 102.

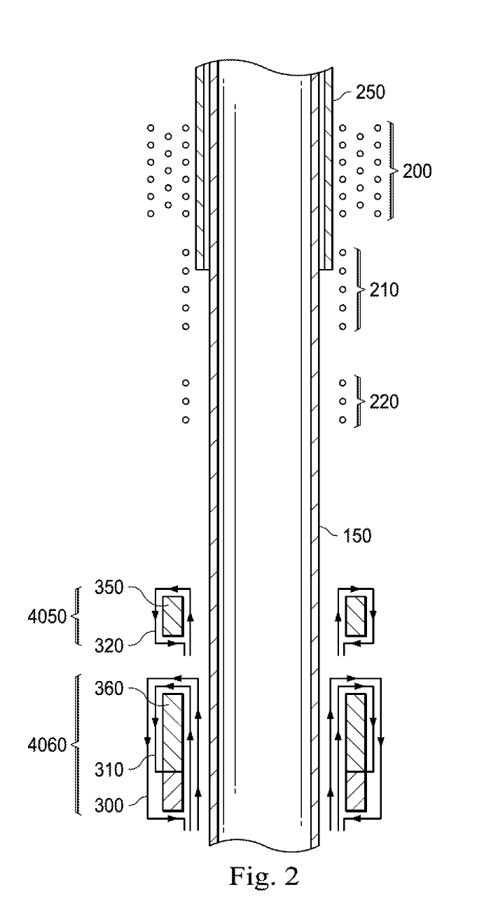

FIG. 2 illustrates a cross-sectional view of a casing 150 with different implementations of nodes along a casing core, according to certain embodiments of the present disclosure. The casing 150 illustrated in FIG. 2 may correspond to the casing string 106 illustrated in FIG. 1. As illustrated in FIG. 2, nodes along the casing may comprise wirings 200 that may be wrapped around a sensor core 250. In one or more embodiments, some of the wirings 200 may comprise a first number of turns around the sensor core 250, and some other of the wirings 200 may comprise a second number of turns around the sensor core 250, wherein the first number of turns is different than the second number of turns. A node comprising fewer turns may operate at a higher resonant frequency having a shorter propagation range. Although having a shorter propagation range, this node may be characterized with a higher bandwidth, where more information can be communicated to other nodes (receivers) for a certain time period (i.e., a communication throughput is higher). In contrast, another node located along the casing comprising more wiring turns may operate at a lower resonant frequency having a longer propagation range. However, this node may be characterized with a smaller bandwidth, where fewer information can be communicated to other nodes (receivers) for a certain time period (i.e., communication throughput is smaller).

For certain embodiments, a plurality of nodes located along the casing 150 may communicate with each other and other receivers (e.g., the receivers 124 and 126 of the well system 100 illustrated in FIG. 1). In one or more embodiments, data communicated among the nodes may comprise information where a specific fluid is positioned along the casing 150 at any time (e.g., during and/or after cementing operation), which can be of crucial importance for evaluating quality of the cementing operation in a wellbore. In an embodiment of the present disclosure, the information about the fluid positions may be provided to the nodes along the casing 150 from RF MEMS tags placed in fluids flowing along the casing 150 in an annulus region of a wellbore during the cementing operation.

In one or more embodiments, a set of nodes along the casing 150 adjacent to each other may simultaneously communicate with at least one receiving node (e.g., receiver 124 and/or receiver 126 from FIG. 1, or one or more other nodes located along the casing 150 illustrated in FIG. 2). Each node from the set of adjacent nodes may be designed and configured to utilize a different resonant frequency for communication. In an embodiment, each resonant frequency is may be located in a high frequency spectrum, which may facilitate achieving a larger information bandwidth (i.e., more information may be communicated within a predetermined time period). In addition, signals transmitted from the adjacent nodes may have non-overlapping bandwidths (e.g., bandwidths separated by a predetermined guard interval). In this way, interference between signals transmitted from different adjacent nodes can be substantially mitigated, i.e., more reliable communication may be achieved during wellbore operations.

As further illustrated in FIG. 2, in one or more embodiments, a node located along the casing 150 may comprise a set of wirings 210 that are wholly or partially placed on the same sensor core 250. Alternatively or additionally, a node located along the casing 150 may comprise a set of wirings 220 that are physically separated (e.g., by 1 cm to 1 m, more specifically, 10 cm) from the sensor core 250.

For certain embodiments of the present disclosure, toroidally wound coils may be employed around the casing 150 for designing nodes capable of multi-frequency communications. In one or more embodiments, as illustrated in FIG. 2, node units 4050 and 4060 may be physically separated and utilize different core materials 350 and 360. For example, node 320 may use core material 350 and node 300 may use core material 360. In one or more other embodiments, core materials of different nodes may be the same. For example, as illustrated in FIG. 2, nodes (coils) 300 and 310 may utilize the same core 360.

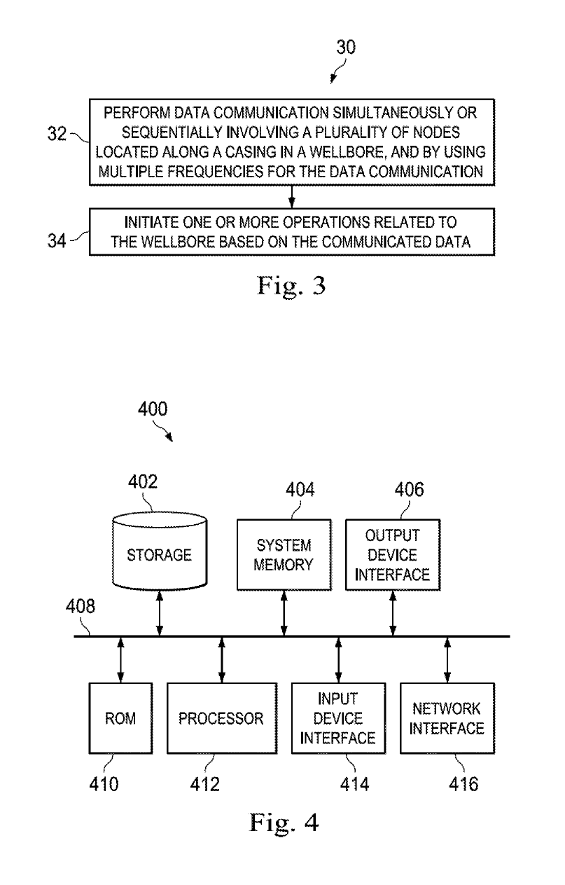

Discussion of an illustrative method of the present disclosure will now be made with reference to FIG. 3, which is a flow chart 30 of a method for multi-frequency communications in wellbore operations such as during and/or after cementing operation, according to certain embodiments of the present disclosure. The method begins at 32 by performing data communication simultaneously, or sequentially, involving a plurality of nodes (e.g., nodes 118 from FIG. 1, nodes related to embodiments illustrated in FIG. 2) located along a casing in a wellbore (e.g., casing 106 of wellbore 102 from FIG. 1, casing 150 illustrated in FIG. 2), and by using multiple frequencies for the data communication. At 34, one or more operations related to the wellbore (e.g., cementing operations related to an annulus between the casing and a reservoir formation of the wellbore) may be initiated based on the data communicated by the plurality of nodes located along the casing in the wellbore.

FIG. 4 is a block diagram of an illustrative computing system 400 in which embodiments of the present disclosure may be implemented adapted for multi-frequency communications in wellbore operations such as during and/or after cementing operation. For example, some operations of method 30 of FIG. 3, as described above, may be implemented using the computing system 400. The computing system 400 can be a computer, phone, personal digital assistant (PDA), or any other type of electronic device. Such an electronic device includes various types of computer readable media and interfaces for various other types of computer readable media. In one or more embodiments, the computing system 400 may be an integral part of the receiver device 126 of the well system 100 illustrated in FIG. 1. For example, the computing system 400 may be configured to receive from a plurality of nodes 118 (e.g., using multi-frequency communications) information related to characteristics of one or more fluids 105 located external to the casing string 106 in the annulus 107 in the vicinity of each of the plurality of nodes 118. The computing system 400 may be further configured to process the received information about fluid locations, provide visual information to a well operator about fluid locations along the casing during and/or after the cementing operation, and initiate appropriate operation(s) related to the wellbore 102 (e.g., one or more corrective cementing operations) based on the information about locations of fluids along the casing string 106.

As shown in FIG. 4, the computing system 400 includes a permanent storage device 402, a system memory 404, an output device interface 406, a system communications bus 408, a read-only memory (ROM) 410, processing unit(s) 412, an input device interface 414, and a network interface 416. The bus 408 collectively represents all system, peripheral, and chipset buses that communicatively connect the numerous internal devices of the computing system 400. For instance, the bus 408 communicatively connects the processing unit(s) 412 with the ROM 410, the system memory 404, and the permanent storage device 402.

From these various memory units, the processing unit(s) 412 retrieves instructions to execute and data to process in order to execute the processes of the subject disclosure. The processing unit(s) can be a single processor or a multi-core processor in different implementations.

The ROM 410 stores static data and instructions that are needed by the processing unit(s) 412 and other modules of the computing system 400. The permanent storage device 402, on the other hand, is a read-and-write memory device. This device is a non-volatile memory unit that is stores instructions and data even when the computing system 400 is off. Some implementations of the subject disclosure use a mass-storage device (such as a magnetic or optical disk and its corresponding disk drive) as the permanent storage device 402.

Other implementations use a removable storage device (such as a floppy disk, flash drive, and its corresponding disk drive) as the permanent storage device 402 Like the permanent storage device 402, the system memory 404 is a read-and-write memory device. However, unlike the storage device 402, the system memory 404 is a volatile read-and-write memory, such a random access memory. The system memory 404 stores some of the instructions and data that the processor needs at runtime. In some implementations, the processes of the subject disclosure are stored in the system memory 404, the permanent storage device 402, and/or the ROM 410. For example, the various memory units include instructions for computer aided pipe string design based on existing string designs in accordance with some implementations. From these various memory units, the processing unit(s) 412 retrieves instructions to execute and data to process in order to execute the processes of some implementations.

The bus 408 also connects to the input and output device interfaces 414 and 406. The input device interface 414 enables the user to communicate information and select commands to the computing system 400. Input devices used with the input device interface 414 include, for example, alphanumeric, QWERTY, or T9 keyboards, microphones, and pointing devices (also called “cursor control devices”). The output device interfaces 406 enables, for example, the display of images generated by the computing system 400. Output devices used with the output device interface 406 include, for example, printers and display devices, such as cathode ray tubes (CRT) or liquid crystal displays (LCD). Some implementations include devices such as a touchscreen that functions as both input and output devices. It should be appreciated that embodiments of the present disclosure may be implemented using a computer including any of various types of input and output devices for enabling interaction with a user. Such interaction may include feedback to or from the user in different forms of sensory feedback including, but not limited to, visual feedback, auditory feedback, or tactile feedback. Further, input from the user can be received in any form including, but not limited to, acoustic, speech, or tactile input. Additionally, interaction with the user may include transmitting and receiving different types of information, e.g., in the form of documents, to and from the user via the above-described interfaces.

Also, as shown in FIG. 4, the bus 408 also couples the computing system 400 to a public or private network (not shown) or combination of networks through a network interface 416. Such a network may include, for example, a local area network (“LAN”), such as an Intranet, or a wide area network (“WAN”), such as the Internet. Any or all components of the computing system 400 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored is on the circuit itself. Accordingly, some of the operations of method 30 of FIG. 3, as described above, may be implemented using the computing system 400 or any computer system having processing circuitry or a computer program product including instructions stored therein, which, when executed by at least one processor, causes the processor to perform functions relating to these methods.

As used in this specification and any claims of this application, the terms “computer”, “server”, “processor”, and “memory” all refer to electronic or other technological devices. These terms exclude people or groups of people. As used herein, the terms “computer readable medium” and “computer readable media” refer generally to tangible, physical, and non-transitory electronic storage mediums that store information in a form that is readable by a computer.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs implemented on the respective computers and having a client-server relationship to each other. In some embodiments, a server transmits data (e.g., a web page) to a client device (e.g., for purposes of displaying data to and receiving user input from a user interacting with the client device). Data generated at the client device (e.g., a result of the user interaction) can be received from the client device at the server.

It is understood that any specific order or hierarchy of operations in the processes disclosed is an illustration of exemplary approaches. Based upon design preferences, it is understood that the specific order or hierarchy of operations in the processes may be rearranged, or that all illustrated operations be performed. Some of the operations may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Furthermore, the illustrative methods described herein may be implemented by a system including processing circuitry or a computer program product including instructions which, when executed by at least one processor, causes the processor to perform any of the methods described herein.

A method for performing multi-frequency communications in wellbore operations has been described and may generally include: performing data communication involving a plurality of nodes located along a casing in a wellbore, and by using multiple frequencies for the data communication.

For the foregoing embodiments, the method may include any one of the following operations, alone or in combination with each other: Initiating one or more operations related to the wellbore based on the communicated data; Configuring a first node of the plurality of nodes to use a first resonant frequency for the data communication; Configuring a second node of the plurality of nodes to use a second resonant frequency for the data communication, the first resonant frequency is lower than the second resonant frequency; Configuring the first node comprises wrapping first turns of coil around the casing; Configuring the second node comprises wrapping second turns of coil around the casing, the first turns of coil comprises more turns of coil around the casing than the second turns of coil; Configuring the first node and the second node as toroidally wound coils; Separating physically a first core material of the first node from a second core material of the second node; Configuring the first node and the second node to share a common core material; Performing the data communication involving the plurality of nodes comprises performing the data communication by simultaneously transmitting, from a set of adjacent nodes of the plurality of nodes, signals having non-overlapping frequency bandwidths; Obtaining, from the plurality of nodes, information about one or more fluids flowing through an annulus region between the casing and a reservoir formation of the wellbore.

The data communication involving the plurality of nodes is performed simultaneously; A first propagation range for the data communication associated with the first node is longer than a second propagation range for the data communication associated with the second node; A first bandwidth for the data communication associated with the first node is smaller than a second bandwidth for the data communication associated with the second node.

Likewise, a system for performing multi-frequency communications in wellbore operations has been described and includes: a plurality of nodes located along a casing in a wellbore configured to perform data communication using multiple frequencies.

For any of the foregoing embodiments, the system may include any one of the following elements, alone or in combination with each other: the plurality of nodes is configured to simultaneously perform the data communication; at least one processor configured to process the data communicated by the plurality of nodes, wherein the at least one processor is further configured to initiate one or more operations of the wellbore based on the processed data; a first node of the plurality of nodes is configured to use a first resonant frequency for the data communication; a second node of the plurality of nodes is configured to use a second resonant frequency for the data communication; the first resonant frequency is lower than the second resonant frequency; the first node is configured by wrapping first turns of coil around the casing; the second node is configured by wrapping second turns of coil around the casing; the first turns of coil comprises more turns of coil around the casing than the second turns of coil; the first node and the second node are configured as toroidally wound coils; a first core material of the first node is physically separated from a second core material of the second node; the first node and the second node are configured to share a common core material; a set of adjacent nodes of the plurality of nodes is configured to perform the data communication by simultaneously transmitting signals having non-overlapping frequency bandwidths; the at least one processor is further configured to obtain, from the plurality of nodes, information about one or more fluids flowing through an annulus region between the casing and a reservoir formation of the wellbore, and initiate the one or more operations related to cementing of the wellbore based on the obtained information; the one or more fluids are pumped into the annulus region using a pump.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., is accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

While specific details about the above embodiments have been described, the above hardware and software descriptions are intended merely as example embodiments and are not intended to limit the structure or implementation of the disclosed embodiments. For instance, although many other internal components of computer system 700 are not shown, those of ordinary skill in the art will appreciate that such components and their interconnection are well known.

In addition, certain aspects of the disclosed embodiments, as outlined above, may be embodied in software that is executed using one or more processing units/components. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives, optical or magnetic disks, and the like, which may provide storage at any time for the software programming.

Additionally, the flowchart and block diagrams in the figures illustrate the architecture, functionality, and operation of possible implementations of systems, methods and computer program products according to various embodiments of the present disclosure. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The above specific example embodiments are not intended to limit the scope of the claims. The example embodiments may be modified by including, excluding, or combining one or more features or functions described in the disclosure.

1. A method for performing multi-frequency communications in wellbore operations, the method comprising:
performing data communication involving a plurality of nodes located along a casing in a wellbore, and by using multiple frequencies for the data communication.

2. The method of claim 1, wherein the data communication involving the plurality of nodes is performed simultaneously.

3. The method of claim 1, further comprising initiating one or more operations related to the wellbore based on the communicated data.

4. The method of claim 1, further comprising:
configuring a first node of the plurality of nodes to use a first resonant frequency for the data communication; and
configuring a second node of the plurality of nodes to use a second resonant frequency for the data communication, the first resonant frequency is lower than the second resonant frequency.

5. The method of claim 4, wherein:
a first propagation range for the data communication associated with the first node is longer than a second propagation range for the data communication associated with the second node; or
a first bandwidth for the data communication associated with the first node is smaller than a second bandwidth for the data communication associated with the second node.

6. (canceled)

7. The method of claim 4, wherein:
configuring the first node comprises wrapping first turns of coil around the casing and configuring the second node comprises wrapping second turns of coil around the casing, the first turns of coil comprises more turns of coil around the casing than the second turns of coil; or
the method further comprises configuring the first node and the second node as toroidally wound coils.

8. (canceled)

9. The method of claim 7, further comprising:
physically separating a first core material of the first node from a second core material of the second node; or
configuring the first node and the second node to share a common core material.

10. (canceled)

11. The method of claim 1, wherein performing the data communication involving the plurality of nodes comprises:
performing the data communication by simultaneously transmitting, from a set of adjacent nodes of the plurality of nodes, signals having non-overlapping frequency bandwidths.

12. The method of claim 1, further comprising:
obtaining, from the plurality of nodes, information about one or more fluids flowing through an annulus region between the casing and a reservoir formation of the wellbore.

13. A system for performing multi-frequency communications in wellbore operations, the system comprising:
a plurality of nodes located along a casing in a wellbore configured to perform data communication using multiple frequencies.

14. The system of claim 13, wherein the plurality of nodes is configured to simultaneously perform the data communication.

15. The system of claim 13, further comprising:
at least one processor configured to process the data communicated by the plurality of nodes, wherein
the at least one processor is further configured to initiate one or more operations of the wellbore based on the processed data.

16. The system of claim 13, wherein:
a first node of the plurality of nodes is configured to use a first resonant frequency for the data communication;
a second node of the plurality of nodes is configured to use a second resonant frequency for the data communication; and
the first resonant frequency is lower than the second resonant frequency.

17. The system of claim 16, wherein a first propagation range for the data communication associated with the first node is longer than a second propagation range for the data communication associated with the second node.

18. The system of claim 16, wherein a first bandwidth for the data communication associated with the first node is smaller than a second bandwidth for the data communication associated with the second node.

19. The system of claim 16, wherein:
the first node is configured by wrapping first turns of coil around the casing, the second node is configured by wrapping second turns of coil around the casing, and the first turns of coil comprises more turns of coil around the casing than the second turns of coil; or
the first node and the second node are configured as toroidally wound coils.

20. (canceled)

21. The system of claim 19, wherein:
a first core material of the first node is physically separated from a second core material of the second node; or
the first node and the second node are configured to share a common core material.

22. (canceled)

23. The system of claim 13, wherein a set of adjacent nodes of the plurality of nodes is configured to perform the data communication by simultaneously transmitting signals having non-overlapping frequency bandwidths.

24. The system of claim 13, wherein the at least one processor is further configured to:
obtain, from the plurality of nodes, information about one or more fluids flowing through an annulus region between the casing and a reservoir formation of the wellbore; and
initiate the one or more operations related to cementing of the wellbore based on the obtained information.

25. The system of claim 24, wherein the one or more fluids are pumped into the annulus region using a pump.
